(19) United States
(12) Patent Application Publication
(10) Pub. No.: US 2021/0049635 A1
(43) Pub. Date: Feb. 18, 2021

(54) SYSTEMS AND METHODS FOR PROVIDING CUSTOMIZED MERCHANT OFFERS

(71) Applicant: VISA INTERNATIONAL SERVICE ASSOCIATION, San Francisco, CA (US)

(72) Inventors: Prabaharan Subramanian Natarajan, Foster City, CA (US); Amar Mukherjee, Foster City, CA (US); Joe Andriadrose Jayabalan, Foster City, CA (US); Ming-Han Chang, Foster City, CA (US); Sandhya Iyer, Foster City, CA (US); Ajay Chalana, Foster City, CA (US)

(21) Appl. No.: 16/541,779

(22) Filed: Aug. 15, 2019

(51) Int. Cl. G06Q 30/02; G06N 20/00

(52) U.S. Cl. CPC G06Q 30/0224; G06Q 30/0209; G06Q 30/0212; G06Q 30/0205; G06Q 30/0201; G06N 20/00

(57) ABSTRACT

A computer-implemented method includes receiving an account number identifier associated with a consumer's account. Using the account number identifier, the consumer's recent transaction history in a transaction data warehouse is located. The transaction data warehouse stores records of purchases made by the consumer with the account at one or more merchants. Computational segmentation scoring is applied to identify a group of leading merchant category codes based on the consumer's recent transaction history. The group of leading merchant category codes are correlated with corresponding merchant offers stored in a central offer repository to provide merchant offers that are customized to the consumer's spending behavior. The customized merchant offers are presented to the consumer at a display interface of a device. The customized offers may be presented as an award or mystery offer in an interactive game.

### TECHNICAL FIELD

Embodiments discussed herein generally relate to systems and methods for providing consumers with customized merchant offers based on their purchase transaction history.

### BACKGROUND

Merchants employ marketing to increase the likelihood of sales with existing or potential customers. One marketing strategy used by merchants involves providing general offers or promotions to consumers that may be downloaded online or sent directly to the consumer by mail, email, or text, for example. These offers may include store-wide discounts, discounts on selected items, gift offers, credit card offers, and rebates. While effective, this marketing strategy may result in only minor increases in overall sales as the offers may not be specifically targeted to each consumer's interests and spending behavior. Being targeted to a general audience, many consumers with varying interests may not be captured or engaged by the offers.

Strategies to provide targeted advertisements and offers to consumers have been described. To increase the likelihood that offers and promotions will translate into increased sales, improved strategies for providing customized offers to consumers according to their individual interests and spending behaviors are needed. Furthermore, there is a need for strategies to enhance the engagement of consumers who receive such customized offers. The embodiments of the present disclosure attempt to provide a technical solution to address these needs.

### SUMMARY

Embodiments disclosed herein provide a technical solution to the above challenges by using electronic computing devices to provide customized merchant offers to the consumer. In one embodiment, a computer-implemented method includes receiving an account number identifier associated with a consumer's account, and using the account number identifier to locate the consumer's recent transaction history in a transaction data warehouse storing records of purchases made by the consumer with the account at one or more merchants. The computer-implemented method further includes applying computational segmentation scoring to identify a group of leading merchant category codes based on the consumer's recent transaction history by identifying a group of leading merchants patronized by the consumer and associating each of the leading merchants with a corresponding merchant category code. The computer-implemented method further includes correlating the group of leading merchant category codes with corresponding merchant offers stored in a central offer repository to provide customized merchant offers, and presenting the customized merchant offers to the consumer at a display interface of a device.

In another embodiment, a system for presenting a consumer with customized merchant offers includes a processor physically configured according to computer executable instructions, a memory physically configured to store computer executable instructions and assist the processor, and an input output circuit in communication with the processor. The system further includes a transaction data warehouse storing records of purchases made by the consumer with an account at one or more merchants, and a segmentation module physically configured to extract the consumer's recent transaction history from the transaction data warehouse and apply computational segmentation scoring to identify a group of leading merchant category codes based on the consumer's recent transaction history. Additionally, the system further includes a filter module physically configured filter merchant offers stored in a central offer repository according to the group of leading merchant category codes and provide customized merchant offers, and a presentation engine physically configured to present the customized merchant offers to the consumer at a display interface of a device.

### BRIEF DESCRIPTION OF THE DRAWINGS

The disclosure may be better understood by reference to the detailed description when considered in connection with the accompanying drawings. The components in the figures are not necessarily to scale, emphasis instead being placed upon illustrating the principles of the disclosure.

FIG. 1 is a schematic representation of a system for presenting a consumer with customized merchant offers, according to one embodiment.

FIG. 2 is an exemplary representation of the consumer's recent transaction history associated with an account held by the consumer, according to one embodiment.

FIG. 3 is a schematic representation of a segmentation module of the system of FIG. 1, according to one embodiment.

FIG. 4 is an exemplary display interface that presents the customized merchant offers to the consumer in an interactive game, according to one embodiment.

FIG. 5 is a schematic representation of a computer device configured to perform the functions of the system of FIG. 1, according to one embodiment.

FIG. 6 is a flowchart illustrating a computer-implemented method for providing the customized merchant offers, according to one embodiment.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated.

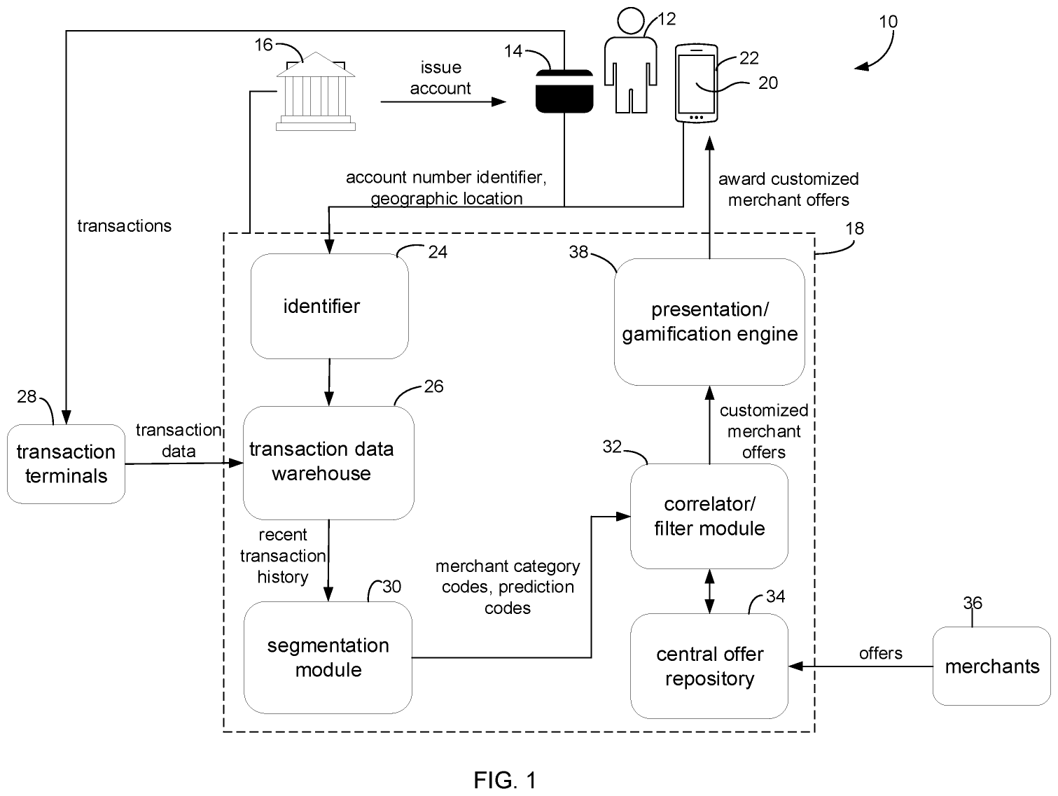

Referring now to the drawings and with specific reference to FIG. 1, a system 10 for presenting a consumer 12 with customized merchant offers is shown. The consumer 12 may hold one or more accounts 14 such as, but not limited to, a credit card account, a debit account, a prepaid account, a bank account, and a stored value account. An issuer 16 may issue the one or more accounts 14 to the consumer 12, and may provide the consumer 12 with a customized offer system 18 that presents customized offers to the consumer 12 which are specifically tailored to the consumer's spending behavior. The customized offers may be provided at a display interface 20 of a device 22 of the consumer 12. As non-limiting examples, the device 12 may be a smartphone, a tablet, or a personal computer. In one embodiment, the customized offer system 18 is an application program that is downloaded onto the consumer's device 22.

The customized offer system 18 may include an identifier 24 to identify the consumer 12, and to identify the consumer's geographic location if geographic location data is available. To identify the consumer 12, the identifier 24 may receive one or more account number identifiers associated with the consumer's account(s) 14 as input. Additionally, the identifier 24 may receive the consumer's current geographic location (latitude and longitude coordinates) as input if such information is available via the consumer's device 22. The system 18 may further include a transaction data warehouse 26 that stores records of purchases or transactions made by the consumer 12 with the account 14 at merchant transaction terminals 28, as well as records of purchases made by other consumers with accounts issued by the issuer 16. The transaction data warehouse 26 may use the consumer's account number identifier to locate transaction data files specific to the consumer 12 and create data files of the consumer's transaction history. The consumer's transaction history may be continuously updated in the transaction data warehouse 26 as the consumer 12 makes purchases with the account 14.

The system 18 may further include a segmentation module 30 configured to extract the consumer's recent transaction history from the transaction data warehouse 26. The consumer's recent transaction history may include details of each of the purchases made by the consumer 12 with the account(s) 14 over a defined time period that may be a period of days, weeks, or months, for example.

As explained in further detail below, the segmentation module 30 may be configured to apply computational segmentation scoring to identify a group of leading merchant category codes based on the consumer's recent transaction history and current geographic location, if available. To identify the group of leading merchant category codes, the segmentation module 30 may identify a group of leading merchants in the consumer's recent transaction history, and associate each of the leading merchants in the group with a corresponding merchant category. For example, the group of leading merchants may be a group of merchants in the consumer's recent transaction history that the consumer 12 spent the most amount of money at and/or most frequently patronized. The merchant category codes may classify the leading merchants according to variables such as, but not limited to, type of retail, type of service, geographic location, and combinations thereof. In addition to identifying the group of leading merchant category codes, the segmentation module 30 may be further configured to apply computational segmentation scoring to provide prediction codes that predict the consumer's future spending behavior. Specifically, the prediction codes may be merchant category codes that will likely populate the consumer's future spending profile.

Referring still to FIG. 1, the segmentation module 30 may output the identified group of leading merchant category codes and/or prediction codes to a correlator/filter module 32. The correlator/filter module 32 may be in communication with a central offer repository 34 that holds current merchant offers provided by various merchants 36. Each of the offers stored in the central offer repository 34 may be tagged with one or more merchant category codes that may or may not correspond with the merchant category codes/prediction codes identified by the segmentation module 30. The module 32 may be configured to filter the offers in the repository 34 according to the group of leading merchant category codes, the prediction codes, and/or the consumer's current geographic location to provide merchant offers that are customized to the consumer 12. Specifically, the correlator/filter module 32 may match the group of leading merchant category codes and prediction codes with corresponding offers stored in the central offer repository 34 to provide the customized merchant offers.

The correlator/filter module 32 may output the customized merchant offers to a presentation/gamification engine 38 that is configured to present the customized merchant offers to the consumer 12 at the display interface 20. To increase the consumer's engagement and incentivize the consumer to view the offers, each of the customized offers may be presented to the consumer 12 as a mystery offer or as an award in an interactive game (see further details below). In one embodiment, the customized merchant offers may be transmitted to the consumer 12 via the application downloaded on the consumer's device 22. In other embodiments, the customized offers may be transmitted to the consumer 12 by text, email, dynamic email, or postal mail. The customized offers may be downloaded, printed, or used directly by the consumer 12 for future purchases at the relevant merchants 36.

The above-described system 18 provides benefits to the issuer 16, the consumer 12, and the merchants 36. By sending personalized offers to their customers, the issuer 16 may benefit by increasing customer interest and loyalty. The issuer 16 may also benefit by receiving revenue for use of the customized offer system 18, as well as increases in account transaction volumes as the consumer applies the customized merchant offers in future purchases. In addition, the consumer 12 may benefit by receiving current merchant offers that are more meaningful and tailored to his or her interests and spending styles. Furthermore, the consumer 12 may enjoy the benefits of purchasing desired items at a discount or with an added gift. The merchants 36 may benefit as the customized offer system 18 matches and targets their current offers to the consumers that are more likely to apply the offers in future transactions. This may translate into increased merchant sales and profits.

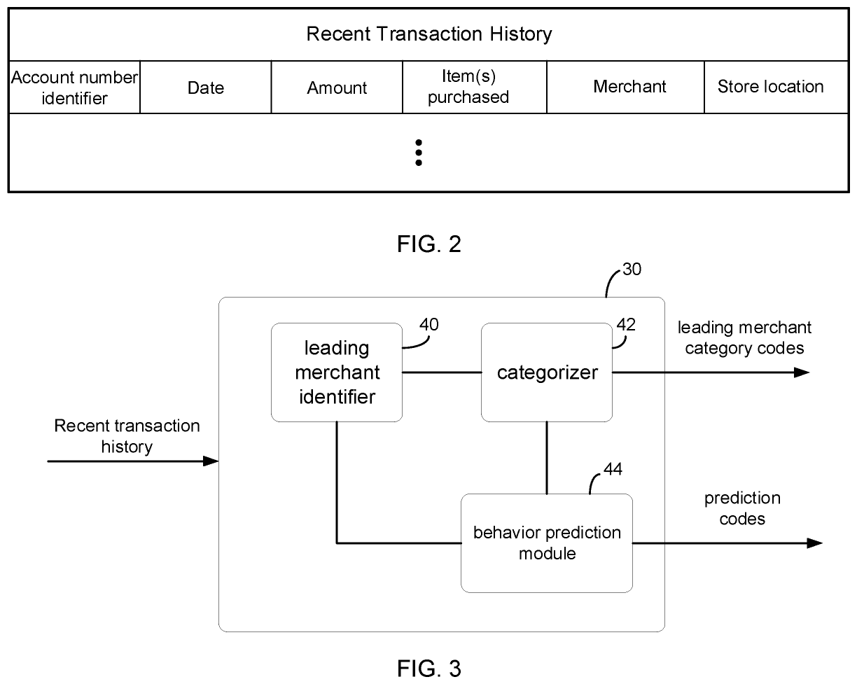

An exemplary representation of the consumer's recent transaction history is shown in FIG. 2. The recent transaction history may list each of purchases made by the consumer 12 with the account 14 over a time frame of days, weeks, months, or other predefined time frames defined by the customized offer system 18, and may be continuously updated as the consumer 12 continues to make purchases with the account 14. For example, for each purchase made over the predefined timeframe, the transaction history may include data such as, but not limited to, the consumer's account number identifier, the date of purchase, the amount of money spent, the item(s) purchased, the merchant, and the store location.

Referring to FIG. 3, the performance of the segmentation module 30 will be described in further detail. Upon extracting or receiving the consumer's recent transaction history from the transaction data warehouse 26, the segmentation module 30 may employ a leading merchant identifier 40 to identify a group of leading merchants patronized by the consumer in the consumer's recent transaction history. Each of the merchants in the consumer's recent transaction history may be given a score based on factors such as, but not limited to, the number of purchases made at the merchant, the total amount of money spent at the merchant, and the frequency of purchases made at the merchant. For example, the leading merchant identifier 40 may give higher scores to the merchants at which the consumer 12 made more purchases and/or spent more money. In addition, higher scores may be given to the merchants in the consumer's current geographic location. In one embodiment, the group of leading merchants may be a group of three to five merchants with the highest scores.

The segmentation module 30 may further include a categorizer 42 configured to associate each of the group of leading merchants with one or more merchant category codes and subcategory codes. The merchant category codes may classify each of the leading merchants identified according to variables such as, but not limited to, type of retail (e.g., women's apparel, children's apparel, automotive, books, entertainment, computers/software, appliances, arts and crafts, health and beauty, jewelry, office supplies, etc.), type of service (e.g., food service, automotive service, cleaning services, etc.), geographic location/store location, and combinations thereof. The sub-category codes may be codes for subcategories within each of the merchant category codes. For example, the categorizer 42 may associate a merchant with a subcategory code for hair care products within a broader merchant code for health and beauty. Based on the group of leading merchants identified by the leading merchant identifier 40, the categorizer 42 may provide a group of leading merchant category/subcategory codes. In one embodiment, the group of leading merchant category codes may include three to five merchant category codes that correspond with the group of leading merchants identified by the leading merchant identifier 40.

Additionally, the segmentation module 30 may further include a behavior prediction module 44 configured to provide prediction codes that predict the consumer's future spending behavior based on the consumer's recent transaction history. The behavior prediction module 44 may apply machine learning to determine the consumer's interests according to data in the consumer's recent transaction history, and predict the likelihood that the consumer will purchase certain items or make purchases at certain merchants in the near future. The prediction codes may be merchant category codes and subcategory codes that the behavior prediction module 44 predicts will populate the consumer's future spending profile. By applying machine learning, the behavior prediction module 44 may operate more efficiently and provide increasingly more accurate prediction codes over time and with increasing transaction data specific to the consumer 12.

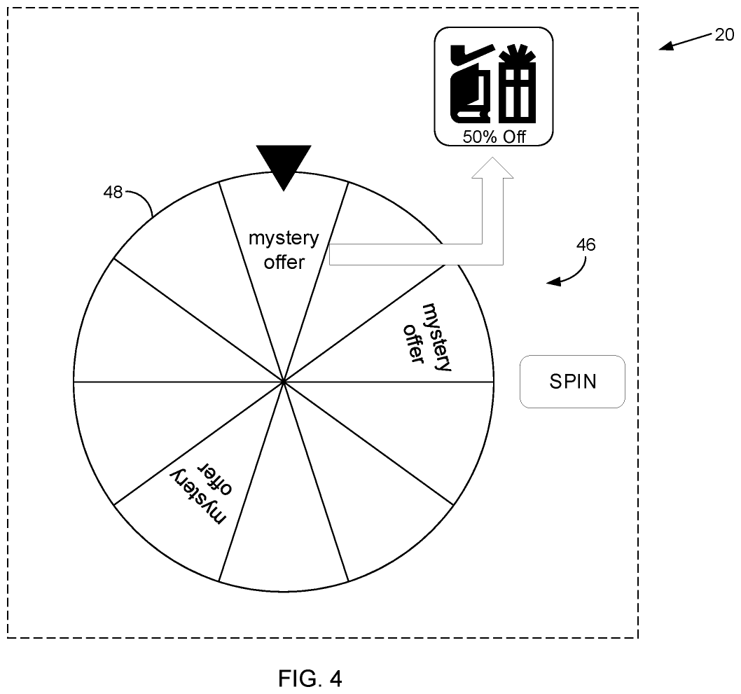

FIG. 4 shows an exemplary display interface 20 presented to the consumer 12 by the presentation/gamification engine 38. In this non-limiting example, the customized offers are presented to the consumer 12 in an interactive game 46. For example, the consumer 12 may spin a wheel 48 by selecting “spin” and receive one or more of the customized offers as a mystery offer that is revealed when the wheel 48 lands on the mystery offer. In one embodiment, the interactive game 46 may include three to five mystery offers that each correspond with the one of customized offers selected according to the leading merchant category codes. In other embodiments, the customized offers may be presented as awards or mystery offers that are revealed in other types of interactive games.

The customized offers presented to the consumer 12 (as an award or mystery offer) may be updated periodically according to the consumer's changing transaction history. An analysis engine may be used to select a game from a plurality of games that may reflect the transactions of a user. For example, if the user is heavy purchaser of hair products, a game may be presented that has a theme related to hair or hair products. Logically, the game may be modified on the fly to substitute products of interest as part of the game. For example, hair products may be appropriate for one buyer while brake pads may be appropriate for another buyer. The presentation/gamification engine 38 may be capable of substituting images or themes by obtaining images of products or service purchased by consumers 12 and substituting the images into the game.

The presentation/gamification engine 38 may take on a variety of forms and perform a variety of functions. In one embodiment, presentation/gamification engine 38 may present games that are created by the merchant where the games may be related to the merchant. In another embodiment, the games, videos or interactive events that may be provided by a third party. For example, a user may be presented the option to watch a movie from a third party as a prize. As another example, a user may be presented the option to play a popular online game or gain points for an online game or for another account. The presentation/gamification engine 38 may be physically configured to make the presentation of games or videos or prizes seamless to the user such that additional log-ins or acceptance of terms may not be required.

In another aspect, machine learning may be used to improve the presentation/gamification engine 38 over time. The machine learning engine (not shown) may review past gamification efforts and modifications and analyze the results of those efforts. For example, some efforts may have been more successful than others. By using more of the successful efforts from the past, an improved response in the future may be possible. The past data may be split into portions where one portion may be used as a training set and a separate portion may be used as a testing set. The portions may be rotated such that each portion may be used as a training set and as a test set. The result of the analysis may be improved gamification efforts over time.

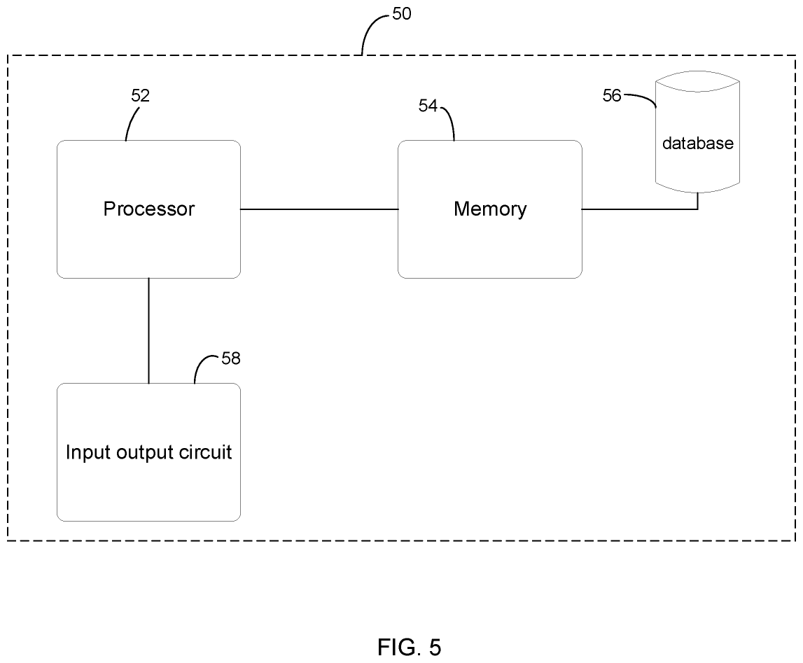

Turning to FIG. 5, a computer device 50 configured to perform at least some of the functions of the customized offer system 18 is shown. The customized offer system 18 may include one or more processors 52 configured to according to computer executable instructions for carrying out the above-described functions of the customized offer system 18. The functions of the customized offer system 18 may be implemented as software code or computer readable instructions that are executed by the processor 52. The computer device 50 may further include a memory 54 configured to store computer executable instructions and to assist the processor 52. A database 56 may be associated with the memory 54 and may store data, such as data included in the transaction data warehouse 26. In addition, an input output circuit 58 may be in communication with the processor 52 and involved in receiving inputs (e.g. account number identifiers, consumer transaction data, etc.) and providing outputs (e.g., customized offers).

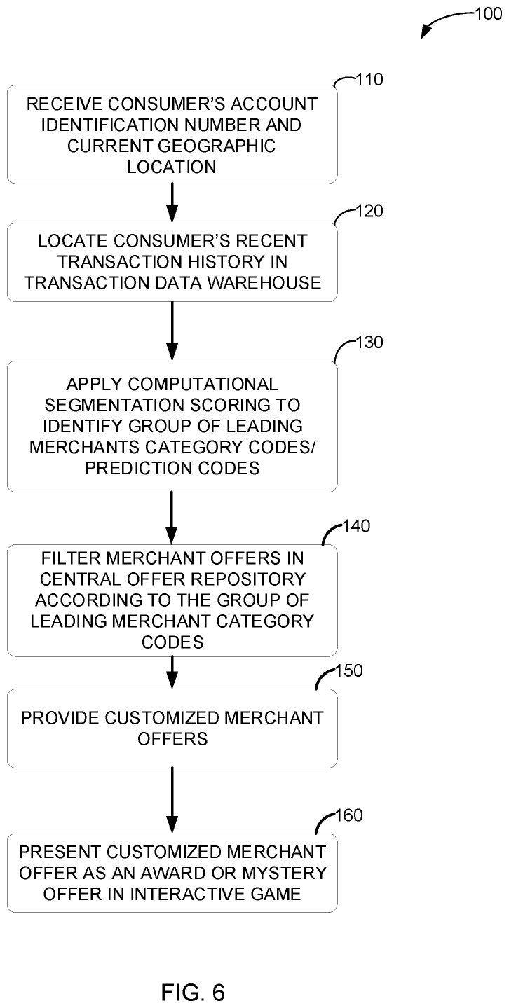

A computer-implemented method 100 for providing customized offers to the consumer 12 is shown in FIG. 6. The method 100 may be performed by the customized offer system 18. At a first block 110, one or more account identification numbers associated with one or more accounts 14 held by the consumer 12 may be received. In addition, the block 110 may involve receiving the consumer's current geographic location if available via the consumer's device 22. Based on the account identification number(s), the consumer's recent transaction history may be located in the transaction data warehouse 26, according to a next block 120.

At a next block 130, computational segmentation scoring may be applied to identify the group of leading merchant category codes and prediction codes based on the consumer's recent transaction history and the current geographic location of the consumer 12, if known. The block 130 may be performed by the segmentation module 30, as explained in detail above. The output of the computational segmentation scoring may be a group of three to five top or leading merchant category codes that the system 18 expects will most likely fall into the consumer's future spending profile. In other embodiments, the output may include less than three or more than five merchant category codes.

At a block 140, current merchant offers stored in the central offer repository 34 may be filtered according to the group of leading merchant category codes/prediction codes identified in block 130. Specifically, the group of leading merchant category codes may be matched with corresponding offers in the central offer repository 34 to provide the customized merchant offers (block 150). At a next block 160, one or more of the customized merchant offers may be presented to the consumer 12 at the display interface 20 of the consumer's device 22. To enhance the consumer's interest in viewing the offers, each of the customized merchant offers may be presented as an award or mystery offer in an interactive game (see, for example, FIG. 4).

It will be understood that the functions of the customized offer system 18 as described above may be combined and performed by a single module or processing unit, or the functions may be distributed over more multiple modules/units in different ways than described above. In this regard, it will be understood that the functional units and modules of the customized offer system 18 as described above and shown in FIGS. 1 and 3 are exemplary and may vary in practice. Additionally, it will be understood that steps of the computer-implemented method 100 of FIG. 6 represents one embodiment of the method, and the steps may be carried out in different orders and/or simultaneously in practice.

The present disclosure provides a solution to the need for providing customized offers to consumers to enhance the likelihood that the offers will translate into increased sales. The customized offers are tailored to the consumer's interests and spending behavior. Additionally, consumer engagement may be enhanced by presenting the offers to the consumer as awards or mystery offers in an interactive game. The present disclosure provides benefits to the account issuer, the consumer, and the merchant. For example, the account issuer may benefit by increasing customer loyalty, revenue, and account transaction volumes. The consumer may benefit by receiving offers suited to his or her spending behavior, and by receiving desired items at a discount. In addition, by targeting their current offers to the right consumers, the merchant may benefit with increased sales and profits.

1. A computer-implemented method comprising:
receiving an account number identifier associated with a consumer's account;
using the account number identifier to locate the consumer's recent transaction history in a transaction data warehouse storing records of purchases made by the consumer with the account at one or more merchants;
applying computational segmentation scoring to identify a group of leading merchant category codes most likely to populate a future spending profile of the consumer based on the consumer's recent transaction history, applying the computational segmentation scoring comprising identifying a group of leading merchants patronized by the consumer based on the consumer's recent transaction history, and associating each of the leading merchants with a corresponding merchant category code;
filtering merchant offers stored in a central offer repository based on the group of leading merchant category codes to provide customized merchant offers for the consumer; and
presenting, via a gamification engine, the customized merchant offers to the consumer as hidden mystery offers revealed via an interactive game at a display interface of a device of the consumer.

2. The computer-implemented method of claim 1, wherein identifying the group of leading merchants patronized by the consumer comprises identifying the group of leading merchants in the consumer's recent transaction history according to factors selected from number of purchases at each of the merchants, frequency of purchases at each of the merchants, amount of money spent at each of the merchants, and combinations thereof.

3. The computer-implemented method of claim 1, wherein the merchant category codes categorize the merchants based on factors selected from type of retail, type of service, geographic location, and combinations thereof.

4. The computer-implemented method of claim 3, wherein the group of leading merchant category codes includes three to five leading merchant category codes.

5. The computer-implemented method of claim 1, further comprising selecting, via the gamification engine, the interactive game from a plurality of games via the gamification engine based on transactions in the consumer's recent transaction history.

6. The computer-implemented method of claim 1, further comprising theming the interactive game via the gamification engine based on products purchased in the consumer's recent transaction history.

7. The computer-implemented method of claim 1, wherein applying computational segmentation scoring further comprises applying computational segmentation scoring to provide prediction codes that predict the consumer's future spending behavior, and wherein correlating the group of leading merchant category codes with corresponding merchant offers further includes correlating the prediction codes with corresponding merchant offers stored in the central offer repository.

8. The computer-implemented method of claim 7, wherein applying computational segmentation scoring further comprises applying machine learning to predict the consumer's future spending behavior.

9. A system for presenting a consumer with customized merchant offers, the consumer having an account, comprising:
a processor physically configured according to computer executable instructions;
a memory physically configured to store computer executable instructions and assist the processor;
an input output circuit in communication to the processor;
a transaction data warehouse storing records of purchases made by the consumer with the account at one or more merchants;
a segmentation module physically configured to extract the consumer's recent transaction history from the transaction data warehouse and apply computational segmentation scoring to identify a group of leading merchant category codes most likely to populate a future spending profile of the consumer based on the consumer's recent transaction history;
a filter module physically configured to filter merchant offers stored in a central offer repository according to the group of leading merchant category codes and provide customized merchant offers for the customer; and
a gamification engine physically configured to present the customized merchant offers to the consumer as hidden mystery offers revealed via an interactive game at a display interface of a device of the consumer.

10. The system of claim 9, wherein the gamification engine is further physically configured to present one or more of the customized merchant offers to the consumer as an award in the interactive game.

11. The system of claim 9, wherein the gamification engine is further physically configured to select the interactive game from a plurality of games based on transactions in the consumer's recent history.

12. The system of claim 9, wherein the segmentation module is physically configured to identify the group of leading merchant category codes by identifying leading merchants patronized by the consumer based on the consumer's recent transaction history, and associating each of the leading merchants with a corresponding merchant category code.

13. The system of claim 12, wherein the merchant category codes categorize the merchants based on factors selected from type of retail, type of service, geographic location, and combinations thereof.

14. The system of claim 13, wherein the segmentation module is further configured to apply computational segmentation scoring to provide prediction codes that predict the consumer's future spending behavior, and wherein the filter module is further configured to filter the merchant offers stored in the central offer repository according to the prediction codes.

15. The system of claim 9, wherein the device is selected from a smartphone, a tablet, and a personal computer.

16. The system of claim 15, wherein the system is an application program downloaded on the device.

17. A computer-implemented method for presenting a consumer with customized merchant offers, the consumer having an account, comprising:
receiving an account number identification associated with the consumer's account;
receiving a current geographic location of the consumer;
using the account number identification to locate the consumer's recent transaction history in a transaction data warehouse storing records of purchases made by the consumer with the account at one or more merchants;
applying computational segmentation scoring to identify a group of leading merchant category codes most likely to populate a future spending profile of the consumer based on the consumer's recent transaction history and the consumer's geographic location, the group of leading merchant category codes categorizing leading merchants patronized by the consumer in the consumer's recent transaction history based on type of retail, type of service, geographic location, and combinations thereof;
filtering merchant offers stored in a central offer repository according to the group of leading merchant category codes to provide customized merchant offers; and
presenting, via a gamification engine, the customized merchant offers to the consumer as hidden mystery offers revealed via an interactive game at a display interface of a device of the consumer.

18. The computer-implemented method of claim 17, further comprising theming the interactive game via the gamification engine based on products purchased in the consumer's recent transaction history.
